(19) United States
(12) Patent Application Publication
(10) Pub. No.: US 2022/0013772 A1
(43) Pub. Date: Jan. 13, 2022

(54) POSITIVE ELECTRODE ACTIVE MATERIAL FOR SODIUM-ION BATTERY

(71) Applicants: RENAULT s.a.s., Boulogne Billancourt (FR); CENTRE NATIONAL DE LA RECHERCHE SCIENTIFIQUE (CNRS), Paris (FR); COLLEGE DE FRANCE, Paris (FR); SORBONNE UNIVERSITE, Paris (FR)

(72) Inventors: Mohamed CHAKIR, Saint-Germain Les Arpajon (FR); Sathiya MARIYAPPAN, Paris (FR); Jean-Marie TARASCON, Paris (FR); Qing WANG, Paris (FR)

(73) Assignees: RENAULT s.a.s., Boulogne Billancourt (FR); CENTRE NATIONAL DE LA RECHERCHE SCIENTIFIQUE (CNRS), Paris (FR); COLLEGE DE FRANCE, Paris (FR); SORBONNE UNIVERSITE, Paris (FR)

(21) Appl. No.: 17/284,202

(22) PCT Filed: Oct. 10, 2019
(86) PCT No.: PCT/FR2019/052414

§ 371 Date: Sep. 23, 2021

(30) Foreign Application Priority Data
Oct. 11, 2018 (FR) 1859417

(51) Int. Cl. H01M 4/525; H01M 4/505; H01M 10/054; H01M 4/62; H01M 10/44; H01M 4/04

(52) U.S. Cl. CPC H01M 4/525; H01M 4/505; H01M 10/054; H01M 2004/028; H01M 10/44; H01M 4/0471; H01M 4/625

(57) ABSTRACT

A positive electrode active material for a sodium-ion battery has the following formula: NaₓNi_{0.5-y}Cu_{y}Mn_{0.5-z}Ti_{z}O₂, in which: -x varies from 0.9 to 1; -y varies from 0.05 to 0.1; -z varies from 0.1 to 0.3. When z is equal to 0.1 and x is equal to 1, then y is not equal to 0.05.

The invention relates to the general field of rechargeable sodium-ion (Na-ion) batteries.

The invention relates more precisely to the positive-electrode active materials for Na-ion batteries, and the positive electrodes comprising them.

The invention also relates to a method for cycling Na-ion batteries.

Na-ion batteries represent one of the most promising alternative solutions to lithium-ion batteries, sodium being of greater interest than lithium from an economic point of view, in particular because of its abundance and its low cost.

However, the Na-ion battery cell assemblies can only be considered at present as prototypes since only tests have been carried out.

Intensive research has been carried out on the positive electrodes for Na-ion batteries. This work has led to a classification of the positive electrodes into two main categories.

The first category contains the polyanionic compounds. Among these polyanionic compounds, the compound Na₃V₂(PO₄)₂F₃ has been identified as being possibly suitable in the context of a use in Na-ion batteries. Indeed, it is characterised in particular by an ease of synthesis, a stability when it is used in humid conditions, or a high specific energy, as described by the document WO 2014/009710. However, the presence of vanadium in the electrode can pose a problem during the use of the Na-ion battery in the medium/long term, given its toxic nature. Moreover, even though better results are obtained with this polyanionic compound, the specific capacity of the latter is limited due to its relatively high molecular mass.

The second category encompasses the lamellar oxides of sodium. These particular oxides have the general formula Na_{b}MO₂, where b is less than or equal to 1, and M designates at least one transition metal. These lamellar oxides seem to be more promising than the polyanionic compounds since they have in particular a lower molecular mass. Moreover, the gravimetric energy density of the lamellar oxides of sodium is greater than that of the compound Na₃V₂(PO₄)₂F₃ approximately 4.5 g/cm³ vs approximately 3 g/cm³). Thus, numerous works on the lamellar oxides of sodium have been undertaken.

A particular material was in particular identified since it had a certain number of advantages. Indeed, the material NaNi_{0.5}Mn_{0.5}O₂ has a theoretical capacity of approximately 240 mAh/g, as described by the document “Study on the reversible electrode reaction of Na₁₋ₓNi_{0.5}Mn_{0.5}O₂ for a rechargeable sodium ion battery”, S. Komaba, N. Yabuuchi, T. Nakayama, A. Ogata, T. Ishikawa, I. Nakai, J. Inorg Chem. 51, 6211-6220 (2012). However, it turns out that the capacity of this material deteriorates over the course of the charge and discharge cycles of the Na-ion battery.

Thus, there is a need to develop new positive-electrode active materials for a sodium-ion battery allowing to overcome the problem of deterioration of the capacity.

It has been discovered that a particular positive-electrode active material allowed to obtain an improved capacity that would not deteriorate with the repetition of the charge and discharge cycles.

The object of the invention is therefore a positive-electrode active material for a sodium-ion battery having the following formula (1):

NaₓNi_{0.5-y}Cu_{y}Mn_{0.5-z}Ti_{z}O₂ (I),

in which:
x varies from 0.9 to 1;
y varies from 0.05 to 0.1;
z varies from 0.1 to 0.3,

with it being understood that if z is equal to 0.1 and x is equal to 1, then y is not equal to 0.05.

Another object of the invention is a method for preparing the active material according to the invention.

The object of the invention is also a positive electrode comprising the active material according to the invention.

Another object of the invention is a cell of an Na-ion battery, including the electrode according to the invention. The invention also relates to an Na-ion battery comprising at least one cell according to the invention.

Finally, the invention also relates to a particular cycling method for the Na-ion batteries comprising a particular positive-electrode active material.

Other advantages and features of the invention will be clearer upon examination of the detailed description and of the appended drawings in which:

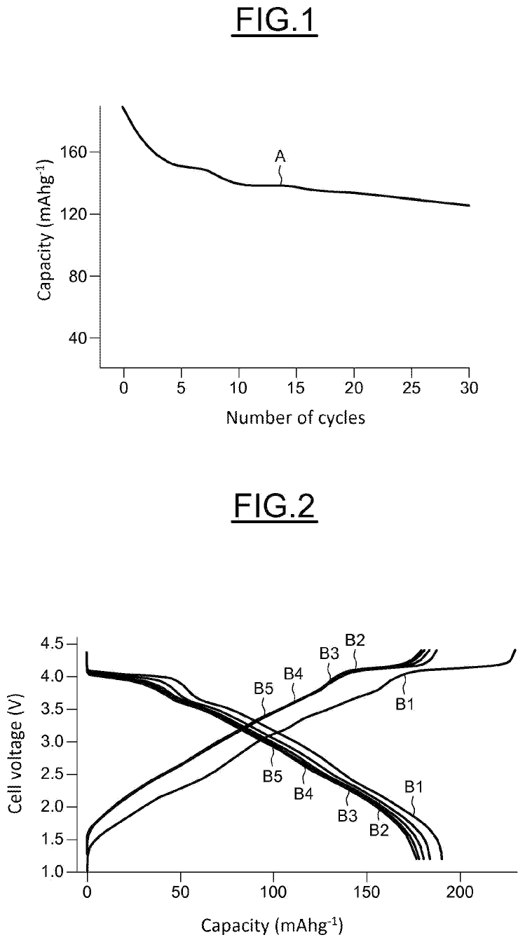

FIG. 1 is a graph representing the capacity of a cell of an Na-ion battery, as a function of the number of charge and discharge cycles;

FIG. 2 is a graph representing the voltage of a cell of an Na-ion battery, as a function of the capacity;

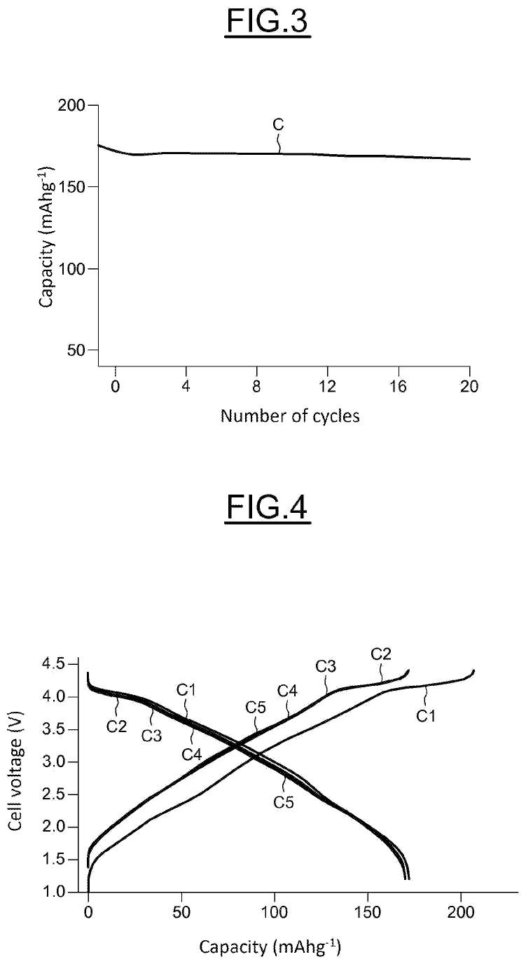

FIG. 3 is a graph representing the capacity of a cell of an Na-ion battery, as a function of the number of charge and discharge cycles;

FIG. 4 is a graph representing the voltage of a cell of an Na-ion battery, as a function of the capacity;

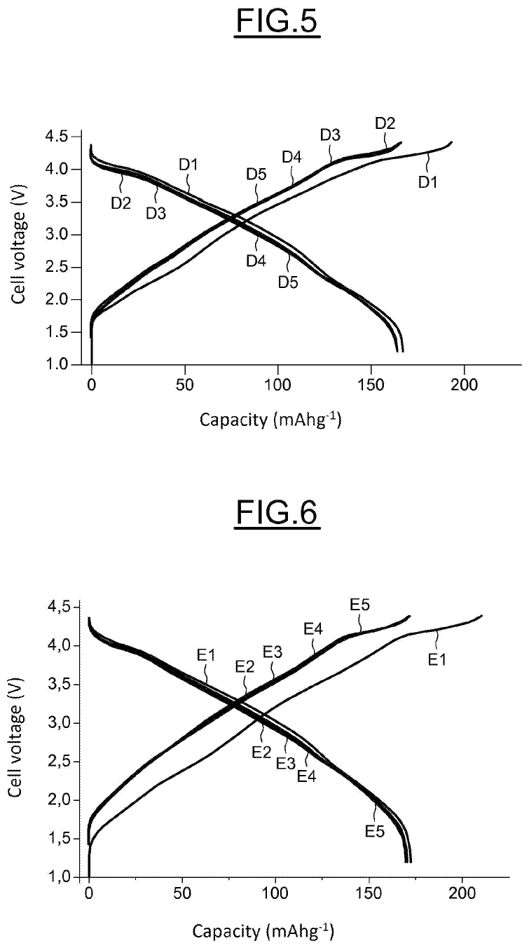

FIG. 5 is a graph representing the voltage of a cell of an Na-ion battery, as a function of the capacity;

FIG. 6 is a graph representing the voltage of a cell of an Na-ion battery, as a function of the capacity;

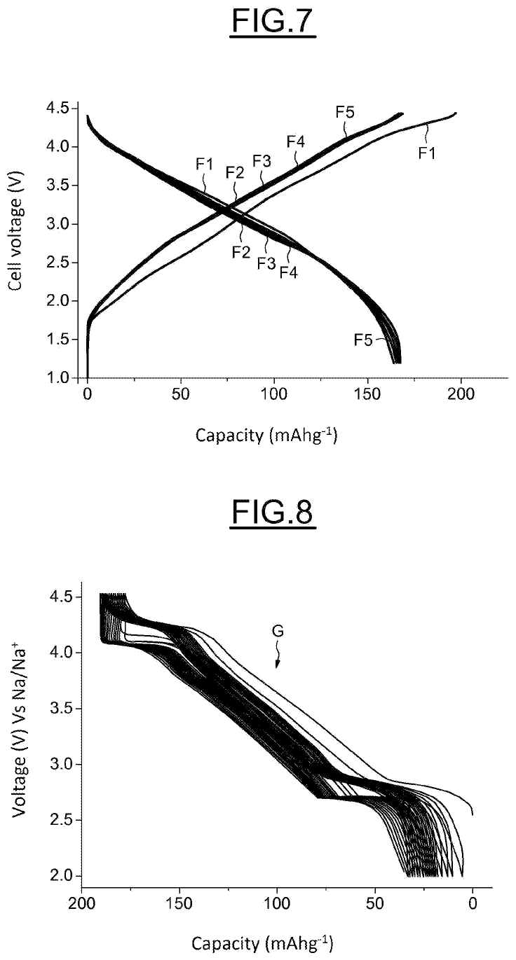

FIG. 7 is a graph representing the voltage of a cell of an Na-ion battery, as a function of the capacity;

FIG. 8 is a graph representing the voltage of a half-cell of an Na-ion battery, as a function of the capacity.

It is specified that the expression “from . . . to . . . ” used in the present description of the invention must be understood as including each of the endpoints mentioned.

The positive-electrode active material for a Na-ion battery according to the invention satisfies the formula (I) as mentioned above.

Preferably, y varies from 0.06 to 0.1, more preferably y is equal to 0.1.

Advantageously, z varies from 0.2 to 0.3.

According to a specific embodiment of the invention, x varies from 0.95 to 1, preferably x is equal to 1.

The object of the invention is also a method for preparing the active material according to the invention comprising the following steps:
(a) mixing at least one compound selected from oxides and/or salts of transition metals with at least one precursor selected from sodium carbonate, sodium nitrate, sodium acetate, sodium sulphate, caustic soda and Na2O and their mixtures;
(b) heating the mixture obtained after step (a) to a temperature ranging from 800 to 1000° C.;
(c) recovering said material.

Preferably, the compound is selected from the oxides.

Preferably, the oxide is selected from NiO, CuO, Mn₂O₃, MnO₂, TiO₂ and their mixtures.

Advantageously, the precursor is sodium carbonate. Thus, preferably, an oxide selected from NiO, CuO, Mn₂O₃, MnO₂, TiO₂ and their mixtures is mixed with the sodium carbonate.

According to a preferred embodiment, the mixture obtained after step (a) is heated to a temperature ranging from 850 to 950° C.

Preferably, step (b) takes place over a period ranging from 6 hours to 20 hours, preferably from 9 hours to 15 hours, more preferably from 11 to 13 hours, in a particularly preferred manner of 12 hours.

Advantageously, step (b) is followed by a step of cooling and of drying. For example, the mixture is heated to 900° C. in an oven for 12 hours, then cooled to 300° C., then removed from the oven.

Another object of the invention is a positive electrode comprising the active material according to the invention.

Preferably, the positive electrode according to the invention further comprises at least one conductive compound.

According to a specific embodiment, the conductive compound is selected from metal particles, carbon, and their mixtures, preferably carbon.

Said metal particles can be particles of silver, of copper or of nickel.

The carbon can be in the form of graphite, carbon black, carbon fibres, carbon nanowires, carbon nanotubes, carbon nanospheres, preferably carbon black.

In particular, the positive electrode according to the invention advantageously comprises the carbon black SuperC65® marketed by Timcal.

Preferably, the content of active material according to the invention varies from 50 to 90% by weight, preferably from 70 to 90% by weight, relative to the total weight of the positive electrode.

Advantageously, the content of conductive compound varies from 10 to 50% by weight, preferably from 10 to 30% by weight, more preferably from 15 to 25% by weight, relative to the total weight of the positive electrode.

The present invention also relates to a cell of an Na-ion battery comprising a positive electrode comprising the active material according to the invention, a negative electrode, a separator and an electrolyte.

Preferably, the battery cell comprises a separator located between the electrodes and acting as an electric insulant. Several materials can be used as separators. The separators are generally composed of porous polymers, preferably polyethylene and/or polypropylene. They can also be made of glass microfibres.

Advantageously, the separator used is a separator made of CAT No. 1823-070® glass microfibres marketed by Whatman.

Preferably, said electrolyte is liquid.

This electrolyte can comprise one or more sodium salts and one or more solvents.

The sodium salt(s) can be selected from NaPF₆, NaClO₄, NaBF₄, NaTFSI, NaFSI, and NaODFB.

The sodium salt(s) are, preferably, dissolved in one or more solvents selected from the aprotic polar solvents, for example, ethylene carbonate, propylene carbonate, dimethyl carbonate, diethyl carbonate, and methyl and ethyl carbonate.

Advantageously, the electrolyte comprises propylene carbonate in a mixture with the sodium salt NaPF₆ at 1M.

The object of the present invention is also an Na-ion battery comprising at least one cell as described above.

The present invention also relates to a method for cycling a sodium-ion battery comprising a negative electrode, a separator, an electrolyte and a positive electrode comprising an active material having the following formula (II):

NaₚNi_{0.5-r}CuᵣMn_{0.5-t}TiₜO₂ (II),

in which:
p varies from 0.9 to 1;
r varies from 0.05 to 0.1;
t varies from 0.1 to 0.3;

comprising the use of a plurality of charge and discharge cycles at voltages ranging from an upper voltage to a lower voltage, the upper voltage ranging from 4.2 to 4.7V, preferably from 4.4 to 4.6V, more preferably equal to 4.5V, the lower voltage ranging from 0.5 to 2.5V, preferably from 1.5 to 2.5V, more preferably equal to 2V,

the cycles being carried out at a cycling rate ranging from C/20 to C, C designating the cycling rate of the sodium-ion battery.

Via the use of the upper voltage ranging from 4.2 to 4.7 in the method for cycling the Na-ion battery, a more protective solid and stable layer called Cathode Electrolyte Interphase (CEI) is generated, with respect to a use of a lower upper voltage, for example less than 4.1V. This CEI, located between the cathode and the electrolyte, is an element essential to the correct operation of the Na-ion battery, since not only does it conduct the sodium ions very well, but it also has the advantage of stopping the catalytic decomposition of the electrolyte.

Advantageously, the active material having the formula (II) has the formula (I).

Preferably, the cycling rate is C/10.

The present invention is illustrated in a non-limiting way by the following examples.

### EXAMPLES

### Example 1

### I. Preparation of the Electrochemical Cells

### 1. Synthesis of the active materials

### 1.1 Synthesis of the active material NaNi_{0.5}Mn_{0.5}O₂

373.45 mg of NiO, 434.7 mg of MnO₂ and 529.95 mg of sodium carbonate are added. The temperature is brought to 850° C. at a rate of 3° C. per minute, then the whole is calcined at 850° C. for 12 hours in an oven. The mixture is then cooled to 300° C. at a rate of 1° C. per minute. This comparative active material is called material A.

### 1.2 Synthesis of the active material NaNi_{0.5}Mn_{0.4}Ti_{0.1}O₂

373.45 mg of NiO, 315.74 mg of Mn₂O₃, 79.87 mg of TiO₂ and 529.95 mg of sodium carbonate are added. The temperature is brought to 900° C. at a rate of 3° C. per minute, then the whole is calcined at 900° C. for 12 hours in an oven. The mixture is then cooled to 300° C. at a rate of 1° C. per minute. This comparative active material is called material B.

### 1.3 Synthesis of the Active Material NaNi_{0.44}Cu_{0.06}Mn_{0.4}Ti_{0.1}O₂

328.64 mg of NiO, 47.73 mg of CuO, 315.74 mg of Mn₂O₃, 79.87 mg of TiO₂ and 529.95 mg of sodium carbonate are added. The temperature is brought to 900° C. at a rate of 3° C. per minute, then the whole is calcined at 900° C. for 12 hours in an oven. The mixture is then cooled to 300° C. at a rate of 1° C. per minute. This active material according to the invention is called material C.

### 1.4 Synthesis of the Active Material NaNi_{0.4}Cu_{0.1}Mn_{0.4}Ti_{0.1}O₂

286.76 mg of NiO, 79.55 mg of CuO, 315.74 mg of Mn₂O₃, 79.87 mg of TiO₂ and 529.95 mg of sodium carbonate are added. The temperature is brought to 900° C. at a rate of 3° C. per minute, then the whole is calcined at 900° C. for 12 hours in an oven. The mixture is then cooled to 300° C. at a rate of 1° C. per minute. This active material according to the invention is called material D.

### 1.5 Synthesis of the Active Material NaNi_{0.45}Cu_{0.05}Mn_{0.3}Ti_{0.2}O₂

345.11 mg of NiO, 39.78 mg of CuO, 236.81 mg of Mn₂O₃, 159.74 mg of TiO₂ and 529.95 mg of sodium carbonate are added. The temperature is brought to 900° C. at a rate of 3° C. per minute, then the whole is calcined at 900° C. for 12 hours in an oven. The mixture is then cooled to 300° C. at a rate of 1° C. per minute. This active material according to the invention is called material E.

### 1.6 Synthesis of the Active Material NaNi_{0.45}C_{0.05}Mn_{0.2}Ti_{0.3}O₂

345.11 mg of NiO, 39.78 mg of CuO, 157.87 mg of Mn₂O₃, 239.61 mg of TiO₂ and 529.95 mg of sodium carbonate are added. The temperature is brought to 900° C. at a rate of 3° C. per minute, then the whole is calcined at 900° C. for 12 hours in an oven. The mixture is then cooled to 300° C. at a rate of 1° C. per minute. This active material according to the invention is called material F.

### 2. Preparation of the Positive Electrodes

Using these materials, six positive electrodes were prepared, respectively called EN-A, EN-B, EN-C, EN-D, EN-E and EN-F. The positive electrodes EN-A and EN-B are comparative electrodes. The electrodes EN-C to EN-F are electrodes according to the invention.

The positive electrode EN-A is manufactured by mixing 80% by weight of the active material A, which is directly transferred in a glove box from the oven without exposure to air, and 20% by weight of the carbon black SuperC65®, the mixture then being ground for 30 minutes using an SPEX 8000M mixer.

The other positive electrodes EN-B to EN-F are manufactured by mixing 80% by weight of the active material, respectively B to F, and 20% by weight of the carbon black SuperC65®, the mixtures then being ground in the same way as for the positive electrode EN-A. In the same way as for the active material A, the active materials B to F are directly transferred in a glove box from the oven without exposure to air.

### 3. Assembly of the Electrochemical Cells

Six electrochemical cells were then prepared respectively comprising the positive electrodes EN-A to EN-F. The cells are respectively named CE-A, CE-B, CE-C, CE-D. CE-E and CE-F.

The assembly of the electrochemical cells is carried out in a glove box using a device consisting of a button cell of the 2032 type.

Each of the cells comprises a separator, a negative electrode and an electrolyte.

### 3.1 Assembly of the Cell CE-A

### Positive Electrode

A mass of 8.13 mg of the electrode EN-A, in the form of a powder, is then spread over a sheet made of aluminium placed in the cell CE-A.

### Separator

Two layers of separator made of CAT No. 1823-070® glass microfibres are used in order to avoid any short-circuit between the positive electrode and the negative electrode during the charge and discharge cycles. These separators are cut according to a diameter of 16.6 mm and a thickness of 400 μm.

### Negative Electrode

An electrode of 1 cm² is obtained by piercing discs of coated hard carbon on a film of a current collector made of aluminium. The active material of hard carbon is approximately 5.20 mg/cm².

### Electrolyte

The electrolyte used comprises a solution composed of 1M NaPF₆ dissolved in propylene carbonate.

### 3.2 Assembly of the Cells CE-B to CE-F

### Positive Electrodes

A mass of 8.50, 9.35, 9.36, 9.35 and 8.75 mg of each of the electrodes EN-B to EN-F, respectively, in the form of a powder, is then spread over a sheet made of aluminium placed in the cells CE-B to CE-F, respectively.

The separators, negative electrodes and electrolytes are identical to those used in the cell CE-A.

### II. Electrochemical Tests

### 1. Comparative Cell CE-A

Galvanostatic cycling was carried out using a BioLogic cycler at a cycling rate of C/20, C designating the capacity of the cell, at voltages ranging from 4.2 to 1.5V. The capacity of the cell CE-A was measured as a function of the number of cycles, as shown by FIG. 1. The change in the capacity is observed in the curve A.

Thus, a degradation of the capacity can be observed with the charge and discharge cycles. A capacity of approximately 130 mAh·g⁻¹ was measured after 30 cycles.

### 2. Comparative Cell CE-B

Galvanostatic cycling was carried out using a BioLogic cycler at a cycling rate of C/20, C designating the capacity of the cell, at voltages ranging from 4.4 to 1.2V. The voltage of the cell CE-B was measured as a function of the capacity, as shown by FIG. 2.

In this FIG. 2, the curve B1 corresponds to the first charge and discharge cycle. The curve B2 corresponds to the second charge and discharge cycle, and so on until the curve B5 which corresponds to the fifth charge and discharge cycle.

A very clear shoulder is observed in the zone ranging approximately from 3.6 to 3.8V. Several plateaus can be observed in these curves B1 to B5, corresponding to processes of phrase transition.

Thus, a degradation of the capacity of the cell CE-B can be observed.

### 3. Cell CE-C According to the Invention

Galvanostatic cycling was carried out using a BioLogic cycler at a cycling rate of C/20, C designating the capacity of the cell, at voltages ranging from 4.4 to 1.2V. The capacity of the cell CE-C was measured as a function of the number of cycles, as shown by FIG. 3. The change in the capacity is observed in the curve C.

Thus, a capacity of approximately 170 mAh·g⁻¹ is measured after 20 cycles.

In comparison to the capacity of the comparative cell CE-A observed in FIG. 1, the capacity of the cell CE-C according to the invention is greater and more stable over the course of the charge and discharge cycles.

Thus, the capacity of the cell comprising the active material according to the invention is improved.

Moreover, the voltage of the cell CE-C was measured as a function of the capacity, as shown by FIG. 4.

In this FIG. 4, the curve C1 corresponds to the first charge and discharge cycle, and so on until the curve C5 which corresponds to the fifth charge and discharge cycle.

The curves C1 to C5 are more linear than the curves B1 to B5.

Thus, the degradation of the capacity of the cell CE-C is not observed as was the case for the cell CE-B. Indeed, the capacity of the cell CE-C is more stable.

### 4. Cell CE-D According to the Invention

Galvanostatic cycling was carried out using a BioLogic cycler at a cycling rate of C/20, C designating the capacity of the cell, at voltages ranging from 4.4 to 1.2V. The voltage of the cell CE-D was measured as a function of the capacity, as shown by FIG. 5.

In this FIG. 5, the curve D1 corresponds to the first charge and discharge cycle, and so on until the curve D5 which corresponds to the fifth charge and discharge cycle.

The curves D1 to D5 are more linear than the curves B1 to B5.

Thus, the degradation of the capacity of the cell CE-D is not observed as was the case for the cell CE-B. Indeed, the capacity of the cell CE-D is more stable.

### 5. Cell CE-E According to the Invention

Galvanostatic cycling was carried out using a BioLogic cycler at a cycling rate of C/20, C designating the capacity of the cell, at voltages ranging from 4.4 to 1.2V. The voltage of the cell CE-E was measured as a function of the capacity, as shown by FIG. 6.

In this FIG. 6, the curve E1 corresponds to the first charge and discharge cycle, and so on until the curve E5 which corresponds to the fifth charge and discharge cycle.

The curves E1 to E5 are more linear than the curves B1 to B5.

Thus, the degradation of the capacity of the cell CE-E is not observed as was the case for the cell CE-B. Indeed, the capacity of the cell CE-E is more stable.

### 6. Cell CE-F According to the Invention

Galvanostatic cycling was carried out using a BioLogic cycler at a cycling rate of C/20, C designating the capacity of the cell, at voltages ranging from 4.4 to 1.2V. The voltage of the cell CE-F was measured as a function of the capacity, as shown by FIG. 7.

In this FIG. 7, the curve F1 corresponds to the first charge and discharge cycle, and so on until the curve F5 which corresponds to the fifth charge and discharge cycle.

The curves F1 to F5 are more linear than the curves B1 to B5. Thus, the degradation of the capacity of the cell CE-F is not observed as was the case for the cell CE-B. Indeed, the capacity of the cell CE-F is more stable.

### Example 2

### I. Preparation of the Electrochemical Half-Cell

### 1. Synthesis of the Active Material NaNi_{0.45}Cu_{0.05}Mn_{0.4}Ti_{0.1}O₂

345.11 mg of NiO, 39.78 mg of CuO, 315.74 mg of Mn₂O₃, 79.87 mg of TiO₂ and 529.95 mg of sodium carbonate are added. The temperature is brought to 900° C. at a rate of 3° C. per minute, then the whole is calcined at 900° C. for 12 hours in an oven. The mixture is then cooled to 300° C. at a rate of 1° C. per minute.

### 2. Preparation of the Positive Electrode

The positive electrode is manufactured by mixing 80% by weight of the active material NaNi_{0.45}Cu_{0.05}Mn_{0.4}Ti_{0.1}O₂, which is directly transferred in a glove box from the oven without exposure to air, and 20% by weight of the carbon black SuperC65®, the mixture then being ground for 30 minutes using an SPEX 8000M mixer.

### 3. Assembly of the Electrochemical Half-Cell

A half-cell was then prepared comprising the positive electrode mentioned above.

The assembly of the half-cell is carried out in a glove box using a device consisting of a Swagelok® connector having a diameter of 12 mm. The half-cell comprises a separator, a negative electrode and an electrolyte.

### Positive Electrode

A mass of 10 mg of the positive electrode, in the form of a powder, is then spread over a piston made of aluminium placed in the half-cell.

### Separator

Two layers of separator made of CAT No. 1823-070® glass microfibres are used in order to avoid any short-circuit between the positive electrode and the negative electrode during the charge and discharge cycles. These separators are cut according to a diameter of 12 mm and a thickness of 500 μm.

### Negative Electrode

Pads having a diameter of 11 mm are cut out of a sheet of metal sodium. The pad obtained is then glued by pressure onto a current collector made of stainless steel. This collector is then deposited on the separator membrane in the cell.

### Electrolyte

The electrolyte used comprises a solution composed of 1M NaPF₆ dissolved in propylene carbonate.

### II. Electrochemical Test

A cycling method comprising the use of a plurality of charge and discharge cycles at voltages ranging from 2 to 4.5V was carried out at a cycling rate of C/10.

The voltage of the half-cell was measured as a function of the capacity, as shown by FIG. 8.

In this FIG. 8, the curve G designates the plurality of the charge and discharge cycles that were carried out.

Thus, the capacity of the half-cell is stable over the repetition of the charge and discharge cycles.

1-12. (canceled)

13. A positive-electrode active material for a sodium-ion battery having the following formula:
NaₓNi_{0.5-y}Cu_{y}Mn_{0.5-z}Ti_{z}O₂,
in which:
x varies from 0.9 to 1;
y varies from 0.05 to 0.1;
z varies from 0.1 to 0.3,
when z is equal to 0.1 and x is equal to 1, then y is not equal to 0.05.

14. The material according to claim 13, wherein y varies from 0.06 to 0.1.

15. The material according to claim 13, wherein z varies from 0.2 to 0.3.

16. The material according to claim 13, wherein x varies from 0.95 to 1.

17. The material according to claim 13, wherein x is equal to 1.

18. A method of manufacturing the active material as defined in claim 13, comprising:
mixing at least one compound selected from oxides and/or salts of transition metals with at least one precursor selected from sodium carbonate, sodium nitrate, sodium acetate, sodium sulphate, caustic soda and Na₂O and their mixtures;
heating the mixture obtained after the mixing to a temperature ranging from 800 to 1000° C.; and
recovering said active material.

19. A positive electrode comprising:
the active material as defined in claim 13.

20. The positive electrode according to claim 19, further comprising at least one conductive compound.

21. The positive electrode according to claim 20, wherein the conductive compound is selected from the metal particles, carbon, and their mixtures.

22. The positive electrode according to claim 20, wherein the conductive compound is carbon.

23. The positive electrode according to claim 22, wherein the carbon is present in the form of graphite, carbon black, carbon fibres, carbon nanowires, carbon nanotubes, or carbon nanospheres.

24. The positive electrode according to claim 22, wherein the carbon is carbon black.

25. A cell of a sodium-ion battery comprising:
the positive electrode as defined in claim 19;
a negative electrode;
a separator; and
an electrolyte.

26. A sodium-ion battery comprising at least one of the cell as defined in claim 25.

27. A method of cycling a sodium-ion battery comprising a negative electrode, a separator, an electrolyte and a positive electrode comprising an active material having the following formula:
NaₚNi_{0.5-r}Cu₄Mn_{0.5-t}TiₜO₂,
in which:
p varies from 0.9 to 1;
r varies from 0.05 to 0.1;
t varies from 0.1 to 0.3,
the method comprising:
using a plurality of charge and discharge cycles at voltages ranging from an upper voltage to a lower voltage, the upper voltage ranging from 4.2 to 4.7V, the lower voltage ranging from 0.5 to 2.5V,
wherein the cycles are carried out at a cycling rate ranging from C/20 to C, C designating the cycling rate of the sodium-ion battery.

28. The method as defined in claim 27, wherein the upper voltage is equal to 4.5V and the lower voltage is equal to 2V.
